(19) United States
(12) Patent Application Publication
(10) Pub. No.: US 2008/0121110 A1
(43) Pub. Date: May 29, 2008

(54) Making Beverages

(76) Inventor: Jacko Ying Biu Lee, Hong Kong (CN)

Correspondence Address: MANELLI DENISON & SELTER, 2000 M STREET NW SUITE 700, WASHINGTON, DC, 20036-3307, US

(21) Appl. No.: 11/658,043

(22) PCT Filed: Jul. 22, 2005
(86) PCT No.: PCT/GB05/02880

§ 371 Date: Jan. 28, 2008

(30) Foreign Application Priority Data
Jul. 24, 2004 (GB) 0416646.8

(51) Int. Cl. A47J 31/54

(52) U.S. Cl. 99/288

(57) ABSTRACT

Boiled water is produced for making beverages by heating water within a boiling chamber (1) to boiling point and holding it at boiling point for a period of time. The boiling chamber has an inverted collector (6) mounted therein. The collector has an upper end (3) and a lower end, the lower end being open to the boiling chamber and the upper end communicating with a passageway (7), but otherwise being closed. Heat to the boiling chamber is shut off or reduced heat after the water has been held in the boiling chamber at boiling point for the said period of time. The water goes off the boil to cause steam and water vapour within the passageway to condense, filling the passageway to set up a siphoning action.

### BACKGROUND OF THE INVENTION

This invention relates to the preparation of hot beverages, for example coffee, tea, cocoa, hot chocolate and other drinks made from concentrates of different kinds.

There are a number of different kinds of automated and semi-automated apparatus for making such beverages. They all rely on heating water in one location and transporting it to another location where the ground coffee, tea leaves, drinks concentrate, etc. is located and where the beverage is actually produced. Some such appliances use electromechanical means, such as electrically operated pumps in the case of pump espresso coffee makers, for transporting the heated water from one location to another. Other such appliances use the heat energy generated by heating water to transport it to the desired location for beverage making.

Thus, in some electrically operated automatic drip coffee makers, a pump action is started from the vapour released as heated water begins to boil. A heating element is wound about a water tube; and, as the heating element heats up, cold water enters the tube from one end through a non-return device and hot water exits at the other. In this process, a pressure head may be created which transports the heated water to a higher level than the initial level of the water supply from which level the water may pour down onto the ground coffee contained on filter paper or in a permanent mesh filter. This transport is sometimes mistakenly referred to as a siphoning action but it is entirely reliant upon creating a pressure head to force the water to an initially higher level than it otherwise would occupy. In some cases, a sealed boiling chamber is employed to use the pressure built up by the expansion of trapped air through heating to expel the heated water through a pipe to be delivered to a desired brewing location.

Krups Stiftung, in DE3312354, propose a fully automatic beverage preparation apparatus in which a beverage collection container at the bottom, a brewing chamber and a water chamber are arranged one above the other. The water chamber is closed by a lid in a vapour tight manner and heat applied to it. The resultant increased pressure within the chamber forces hot water to rise within a so-called siphon tube, the inflow end of which is adjacent the bottom of the water chamber, and the outflow end of which passes through the bottom of the water chamber to the brewing chamber beneath to serve as the inflow to the brewing chamber.

Again, in DE3815354, Krups Stiftung propose an appliance for making hot beverages which has a so-called siphon tube for transferring water from a water chamber to a filter, the tube having an inlet end adjacent the bottom of the water chamber and an outlet end at a lower level at the top of the filter. The water chamber is divided into two chambers interconnected at their bottom. One is open to atmosphere. The other, in which the bottom of the so-called siphon tube is located, is not. The second chamber serves as a steam pressure chamber and has the heating element immediately beneath it. Heating the water in the second chamber causes pressure to rise in that chamber, forcing water into the bottom of the siphon tube at its inlet end.

A major drawback in all of these prior systems which employ what is in effect a pump or pressure action to force water from the heating chamber to the location where the beverage is actually made, whether this be in a separate brewing compartment or in a filter, is that the pump or pressure action commences long before the water reaches boiling point. Consequently, water that is only warm, at most, is employed, at least initially, and in some apparatus throughout the entire beverage preparation process. The temperature of the water is particularly low at the start of the process and this is undesirable for the proper preparation either of good coffee or of acceptable tea. This low temperature has caused many manufacturers to provide auxiliary heat to the collection chamber in which filtered coffee or brewed tea is stored. However, this then produces a further problem, namely that the collected beverage very soon tastes stewed.

At least in some countries, there is also a hygiene problem, in that the beverage is produced with water that has not reached boiling point.

### SUMMARY OF THE INVENTION

The present invention provides a simple but novel solution to these problems.

In accordance with a first aspect of the present invention, there is provided a method of producing boiled water for making beverages, comprising the steps of heating water within a boiling chamber to boiling point and holding it at boiling point for a period of time, the boiling chamber having an inverted collector mounted therein, the collector having an upper end and a lower end, the lower end being open to the boiling chamber and the upper end communicating with a passageway, but otherwise being closed, the passageway being provided by a tube or the like having a first end connected to the upper end of the collector and a second end outside the boiling chamber at a level lower than that of the first end, and the level of water within said boiling chamber being above that of said first end; shutting off or reducing heat to the boiling chamber after the water therein has been held at boiling point for said period of time so that the water goes off the boil to cause steam and water vapour within said passageway to condense, filling said passageway with sufficient water to set up a siphoning action, whereby water that has been boiled within said boiling chamber issues from said second end for making said beverage.

This process differs significantly from the water heating process of prior apparatus in that the siphoning action is set up only after, and as a consequence of, the supply of heat to the boiling chamber being shut off or reduced, and only water that has boiled (namely that has been held at boiling point within the apparatus) is used for making the beverage.

The invention also provides apparatus for carrying out the said method, the apparatus comprising: a boiling chamber arranged for exposure to a source of heat; an inverted collector mounted within the boiling chamber and having an upper end and a lower end, the lower end being open to the boiling chamber, and the upper end communicating with a passageway but otherwise being closed; tube or like means providing the said passageway, and having a first end coupled to the upper end of the collector and having a second end outside the boiling chamber at a level lower than that of said first end.

The apparatus may be embodied as an automatic drip or filter coffee maker, and in that case the second end of the tube communicates with an outlet located above a filter adapted to receive ground coffee and having a filter outlet at its lower end positioned such that a container for coffee may be placed therebeneath.

In an alternative arrangement, the apparatus may be embodied as an automatic tea kettle, the interior of which is divided into two chambers separated by an internal wall of the kettle or into two separately formed chambers mounted adjacent each other; one said chamber serving as the said boiling chamber and either being provided with a heating element or being adapted to be placed adjacent a source of heat, and the other chamber serving as a brewing chamber and being adapted to receive leaf tea or tea bags, the outlet end of the tube being located in the brewing chamber.

When the automatic tea kettle has two separately formed chambers, the passageway may be provided by a first section of tube or like means associated with one chamber and a second section of tube or like means associated with the other chamber, the two said sections communicating with each other when the two chambers are placed in correct register with each other. This arrangement enables the brewing chamber to be removed for cleaning or other purposes.

At least part of the said internal wall separating the brewing chamber from the boiling chamber is preferably double skinned, comprising a first wall and a second wall with a space between them, the lower part of which space is open to the brewing chamber and the upper part of which is open to the boiling chamber, whereby the said internal wall is adapted to serve as a baffle between the two chambers, with a weir on the side adjacent the boiling chamber, so that after siphoning has ceased and the siphon tube has emptied, water that has previously boiled, held within the boiling chamber, may be used to replenish water in the brewing chamber poured off as tea by cascading over the weir and into the said space when the kettle is sufficiently tilted in pouring off tea.

Alternatively, when the automatic tea kettle has two separate chambers, the wall of one said chambers in the region where one chamber is mounted adjacent the other may be double skinned, comprising a first wall and a second wall with a space between them, the lower part of which space is open to the brewing chamber and the upper part of which is open to the boiling chamber when the two chambers are placed in correct register with each other, whereby the said double skinned wall is adapted to serve as a baffle between the two chambers, with a weir on the side adjacent the boiling chamber, so that after siphoning has ceased and the siphon tube has emptied, water that has previously boiled, held within the boiling chamber, may be used to replenish water in the brewing chamber poured off as tea by cascading over the weir and into the said space when the kettle is sufficiently tilted in pouring off tea.

### BRIEF DESCRIPTION OF THE DRAWINGS

The invention is hereinafter more particularly described by way of example only by reference to the accompanying schematic drawings, in which:

FIG. 1 schematically illustrates an embodiment of automatic coffee machine, constructed in accordance with the present invention, at the commencement of heating of water within its boiling chamber;

FIG. 2 is a view generally similar to FIG. 1 showing the apparatus of FIG. 1 in the condition in which heat to the boiling chamber has been shut off or reduced to cause the siphoning action, whereby coffee is produced;

FIG. 3 is a schematic view of an automatic tea kettle, constructed in accordance with the present invention, in the condition in which heating is commenced;

FIG. 4 is a view similar to FIG. 3 showing the automatic tea kettle of FIG. 3 after heating has been shut off or reduced and siphoning has commenced;

FIG. 5 illustrates a preferred embodiment of the automatic tea kettle of FIGS. 3 and 4 with a double skinned baffle wall between the two chambers, the siphon tube and collector being omitted for clarity from this view; and

FIG. 6 shows how the baffle and siphon may be formed in an arrangement in which the brewing and boiling chambers are separable.

### DESCRIPTION OF THE PREFERRED EMBODIMENTS

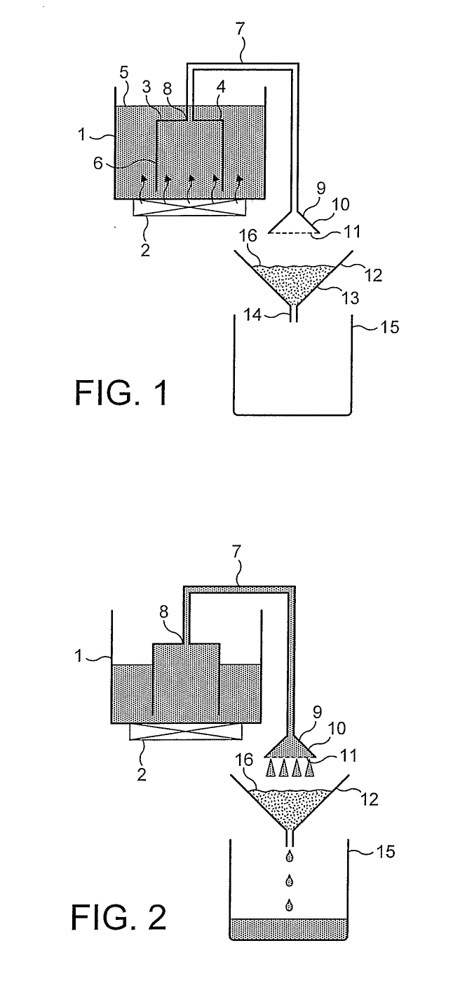

Referring first to FIGS. 1 and 2 which schematically illustrate the operation of an automatic coffee machine embodying the invention, it will be appreciated that these views are highly simplified for the purpose of illustration and omit many of the parts which a man of ordinary skills in this field will appreciate would be present in a practical embodiment of such an automatic coffee machine. The machine illustrated in these drawings includes a water tank 1 adapted to serve as a boiling chamber. The water tank 1 has a heating device 2, preferably an electrical heating device, which may be in the form of an inductive loop or a resistance element arranged for coupling to a source of electric power. Within the water tank 1 is mounted an inverted collector 3. Collector 3 has an upper end 4, here shown below the level 5 of water in the tank, and a lower end 6 that is open to the remainder of the water tank. Coupled to upper end 4 is a tube 7 providing a passageway from the collector. Thus tube 7 has one end 8 coupled to upper end 4 of the collector and a second end 9, in this case provided by a distributor device 10 with a plurality of openings 11, located at a level that is lower both than the level of the first end of the tube and that of the lower end 6 of collector 3. Distributor 10 is arranged for location above a coffee filter 12 which may mount or incorporate a mesh filter adapted substantially to retain coffee grounds but to allow coffee to drip therethrough. Alternatively, the coffee filter 12 may be adapted to fit a coffee filter paper serving the same purpose of substantially retaining coffee grounds while allowing liquid coffee to drip therethrough. As shown in FIGS. 1 and 2, the coffee filter has sloped sides 13 channelling liquid coffee to an outlet 14 at the bottom of the filter, beneath which may be located a coffee pot 15 to collect coffee made by the apparatus.

FIG. 1 shows the apparatus at the commencement of heating. Water within the boiling chamber provided by water tank 1 is heated by heating device 2 until it reaches boiling point. As the water boils steam and water vapour will be given off. Because tube 7 is open at its second end, steam will pass along the tube and issue from its second end. There may even be a partial pumping action of the kind described above and upon which the prior art depends, in the apparatus described herein, but in the present case without any significant quantity of water issuing from end 9. Once the water has been held at boiling point within the boiling chamber for a period of time, the heat produced by heating device 2 is either shut off completely or at least substantially reduced so that the water within the boiling chamber goes off the boil. As a consequence of this steam and/or water vapour within the passageway provided by tube 7 will condense therein, filling that passageway with sufficient water to set up a siphoning action whereby water within water tank 1 that has been boiled will pass through collector 3 into tube 7 and issue from its lower end 9 to be distributed by distributor 10 over the surface of ground coffee 16 located within the coffee filter 12, so producing filter or drip coffee, as shown in FIG. 2, collected in the coffee pot 15. It is particularly to be noted that, while water is being boiled in the system described herein, little or no water will issue from the lower open end 9 of the tube, because the heat energy supplied in this case is insufficient to raise the water substantially above its normal level, water tank 1 being open to atmosphere. It is only after boiling within tank 1 has ceased that the saturated steam within the tube 7 condenses. Once siphoning has been set up in this way by filling the tube 7 with water that has been boiled, the siphoning action will be self-sustaining because the level of end 9 of tube 7 is below the lower end of collector 6, and will continue until the water level 5 within tank 1 of water that has boiled falls to the level of lower end 6, at which point air enters the collector and tube 7 and siphoning ceases.

It will be understood that, in alternative arrangements, rather than employing an electrical heating device 2, any other source of heat such as, for example, a gas flame, could be used.

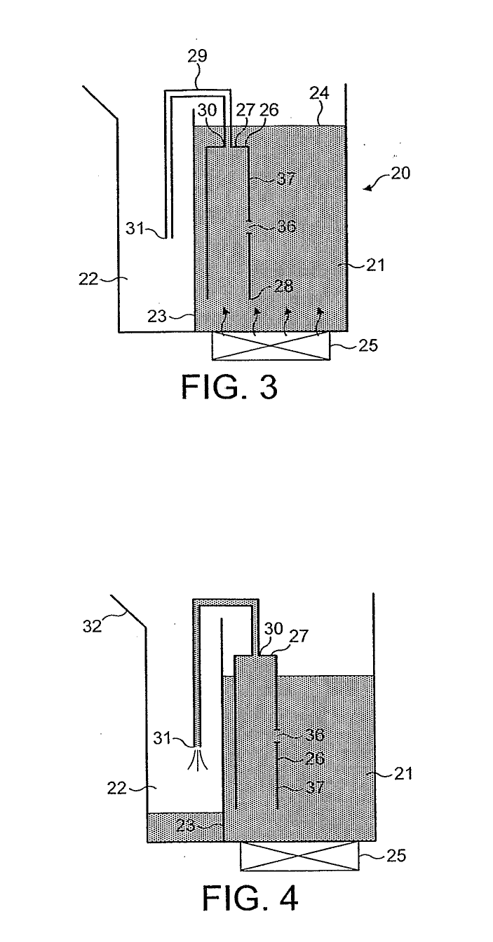

The invention may also be applied to the making of tea, as will be explained further with reference to FIGS. 3, 4 and 5. These Figures are equally schematic and persons skilled in this art will readily appreciate that parts of the automatic tea kettle are omitted from these drawings for clarity in order to illustrate the principle of operation. The interior of automatic tea kettle 20 is divided into two chambers 21 and 22 by an internal wall 23. Although the two chambers 21 and 22 are here shown on opposite sides of a wall 23 which may consist of a single partition across the interior of tea kettle 20, alternative arrangements are feasible. For example, the two chambers may be disposed concentrically, with chamber 21 in the centre and chamber 22 circum-extending thereabout. The two chambers may be separately formed, as explained in more detail below with reference to FIG. 6.

Chamber 21 serves as a boiling chamber and is shown in FIG. 3 filled with water to a water level 24. A heating device 25 is here shown beneath chamber 21 but could be located as a heating element within that chamber. Heating device 25 is preferably electrical and may comprise an induction heating element or a resistive heating element adapted, in either case, to be connected to an external source of electric power in order to heat water within the boiling chamber 21. Within that chamber is provided an inverted collector 26 having an upper end 27 below the normal water level 24 within chamber 21 and a lower end 28. A tube 29 provides a passageway from upper end 27 of collector 26 to chamber 22 which serves as a tea brewing chamber. Thus tube 29 has a first end 30 coupled to upper end 27 of collector 23 and a second end 31 located at a lower level.

In order to make tea using the automatic tea kettle illustrated in FIGS. 3 and 4, loose tea leaves or tea bags are placed within brewing chamber 22 and heating commenced. Water within boiling chamber 21 is heated to boiling point. During this process there may be a minor pumping effect as described above in relation to the prior art arrangements but the heat supplied is insufficient to cause water to fill tube 29 and initiate a siphoning action. However, because the water is heated to boiling point and held at boiling point in chamber 21 for a period, tube 29 is filled with saturated steam. Consequently if the heat supplied by device 25 is cut off or substantially reduced after the water has been held at boiling point, that saturated steam will condense within the tube sufficiently to fill that tube with water and initiate a siphoning action. Once the siphoning action has commenced within tube 29, so that water that has boiled issues from its end 31 within the brewing chamber 22, tea is produced in that chamber; and the siphoning action is self-sustaining until the water level in the two chambers becomes the same, if second end 31 of the tube and lower end 28 of the collector are both at a sufficiently low level to avoid air entering the siphoning system.

However, it is preferred to break the siphoning action, after sufficient water has entered the brewing chamber 22, to avoid tea siphoning back into the boiling chamber 21 as the tea kettle is returned to an upright position after pouring tea. This can be achieved by incorporating a small hole 36 at an appropriate elevation in side wall 37 of the collector 26. During siphoning, once the water level in the boiling chamber 21 is lowered to the level of hole 36, or alternatively if hole 36 is exposed to air as a result of tilting the tea kettle to pour off tea from chamber 22, air will enter hole 36, so breaking the siphoning action.

In an alternative arrangement, the lower end 28 of collector 26 is positioned such that on the first pouring of tea from chamber 22, lower end 28 is exposed to air at least momentarily as the tea kettle is tilted, with the effect that air is let into the siphoning system, breaking the siphoning action.

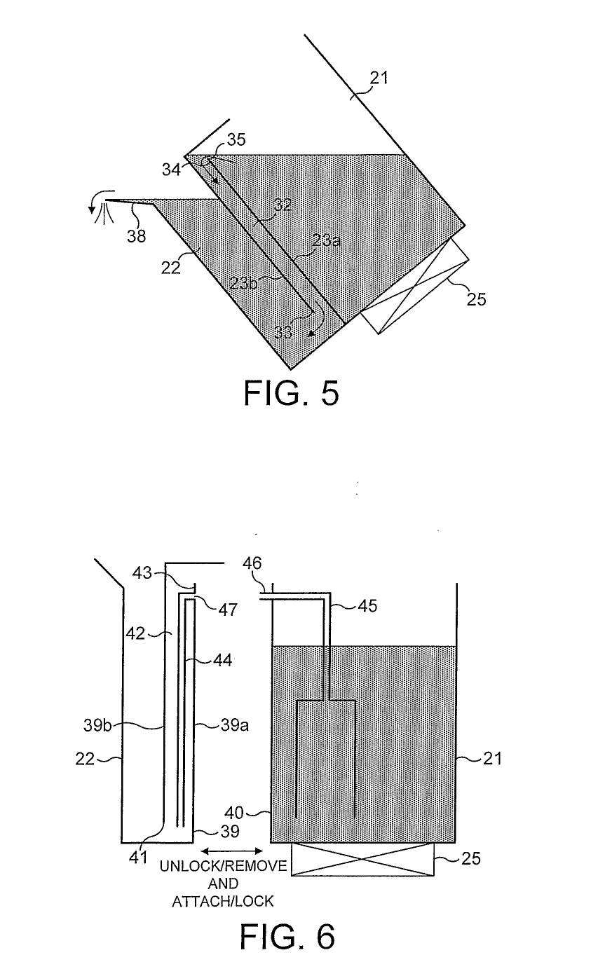

Once the siphoning action has been broken by air entering the system, no further water will pass from chamber 21 to chamber 22 via tube 29. To overcome this and to allow additional water to replenish chamber 22 to refresh and make further tea, as shown in FIG. 5, in our most preferred arrangement of tea kettle, partition wall 23 between the two chambers is preferably double skinned, comprising a first wall 23a and a second wall 23b separated by a space 32 which is open at its bottom end 33 into brewing chamber 22 and open at its upper end 34 into boiling chamber 21. This double skinned baffle arrangement effectively provides a weir over the top end 35 of wall 23a, as shown in FIG. 5 so that water that has already boiled and which still remains within boiling chamber 21 can then cascade over this weir through the space 32 between the two walls 23a and 23b and into the bottom of the brewing chamber 22 so as to replenish liquid poured off from spout 38 as tea. Moreover, since the water level in chamber 21 will fall as the kettle is tilted back to its upright position, and so will fall below the level of the weir 35, there will be no suck-back of tea into the boiling chamber. When the automatic tea kettle is next tilted, for example to pour a further cup of tea, water may again cascade from chamber 21 over weir 35, through space 32 and into the brewing chamber 22.

As in the coffee maker previously described, it will again be appreciated by persons skilled in this art that the siphoning action which causes water that has boiled to pass from the boiling chamber 21 to the brewing chamber 22 only commences after heat to the boiling chamber has been cut off or substantially reduced.

FIG. 6 shows a variation in which the two chambers 21 and 22 are formed separately. Thus, in this arrangement, the brewing chamber 22 is separable from the remainder of the tea kettle, for example for cleaning. To ensure correct registration, and to prevent relative movement, the two chambers are preferably locked together with walls 39 and 40 adjacent each other. Wall 39 of the brewing chamber 22 is shown double-skinned in this embodiment, comprising an outer wall 39a and an inner wall 39b. It will be appreciated that when the two chambers are in correct register with each other, this arrangement replicates the baffle arrangement of FIG. 5, the lower end 41 of the space 42 between the two skins being open to the brewing chamber and the upper end 43 of space 42 being open to the boiling chamber. Also shown in FIG. 6 are two sections 44, 45 of tube, section 44 being associated with the brewing chamber and section 45 being associated with the boiling chamber, and the two such sections together replicating tube 29 of the FIG. 3 arrangement when the two chambers are mounted in correct register with each other. Preferably tube section 45 has an end projection 46 that forms a positive fit in opening 47 of tube section 44 when the two chambers are in correct register. In an alternative arrangement, not illustrated, the double-skinned wall may be wall 40 of the boiling chamber.

Persons skilled in this art will readily appreciate that an express heating device in the form of electrical heating device 25 described above and shown in each of FIGS. 3 to 6, may be omitted if the tea kettle is to be placed over a source of heat, for example a gas flame.

In all the arrangements described above, only water that has been boiled, and so is effectively sterile, is used to make tea or coffee. No water that has yet to reach boiling point is employed. Not only do tea and coffee makers as described above make a superior brew as compared with the prior arrangements described hereinabove, but they do so in an exemplarily hygienic fashion, using only sterile water that has been boiled.

1. A method of producing boiled water for making beverages, comprising the steps of: heating water within a boiling chamber to boiling point and holding it at boiling point for a period of time, the boiling chamber having an inverted collector mounted therein, the collector having an upper end and a lower end, the lower end being open to the boiling chamber and the upper end communicating with a passageway, but otherwise being closed, the passageway being provided by a tube or the like having a first end connected to the upper end of the collector and a second end outside the boiling chamber at a level lower than that of the first end, and the level of water within said boiling chamber being above that of said first end; shutting off or reducing heat to the boiling chamber after the water therein has been held at boiling point for said period of time so that the water goes off the boil to cause steam and water vapour within said passageway to condense, filling said passageway with sufficient water to set up a siphoning action, whereby water that has been boiled within said boiling chamber issues from said second end for making said beverage.

2. A method according to claim 1 further including placing a filter containing ground coffee beneath said second end and collecting liquid that passes through said filter and ground coffee.

3. A method according to claim 1 further including collecting water issuing from said second end in a brewing chamber containing leaf tea, either loose or in one or more teabags.

4. A method according to claim 3, wherein the boiling chamber and the brewing chamber comprise two chambers of a tea kettle.

5. A method according to claim 4, wherein siphoning ceases after a charge of water has passed from the boiling chamber to the brewing chamber, the method further comprising the step of thereafter replenishing water in the brewing chamber poured off as tea by cascading water that has boiled in the boiling chamber over a weir defined between the two said chambers as the kettle is tilted to pour off tea.

6. Apparatus for producing boiled water for making beverages, the apparatus comprising: a boiling chamber arranged for exposure to a source of heat; an inverted collector mounted within the boiling chamber and having an upper end and a lower end, the lower end being open to the boiling chamber, and the upper end communicating with a passageway but otherwise being closed; tube or like means providing the said passageway, and having a first end coupled to the upper end of the collector and having a second end outside the boiling chamber at a level lower than that of said first end.

7. The apparatus according to claim 6, wherein the second end of the tube communicates with an outlet located above a filter adapted to receive ground coffee and having a filter outlet at its lower end positioned such that a container for coffee may be placed therebeneath.

8. The apparatus according to claim 6, wherein the apparatus defines two chambers, one said chamber serving as the said boiling chamber and either being provided with a heating element or being adapted to be placed adjacent a source of heat, and the other chamber serving as a brewing chamber and being adapted to receive leaf tea or tea bags, the outlet end of the tube being located in the brewing chamber.

9. The apparatus according to claim 8, wherein the apparatus defines a kettle having a single external wall, the two said chambers being defined within the said external wall, on opposite sides of an internal wall of the kettle.

10. The apparatus according to claim 9, wherein at least part of the said internal wall is double skinned, comprising a first wall and a second wall defining a space between them, the lower part of which space is open to the brewing chamber and the upper part of which space is open to the boiling chamber, whereby the said internal wall is adapted to serve as a baffle between the two chambers, with a weir on the side adjacent the boiling chamber, so that water that has previously boiled, held within the boiling chamber, may be used to replenish water in the brewing chamber poured off as tea by cascading over the weir and into the said space when the kettle is sufficiently tilted in pouring off tea.

11. The apparatus according to claim 8, wherein the two said chambers are separately formed and adapted to be mounted adjacent each other, the passageway being provided by a first section of tube or like means associated with one chamber and a second section of tube or like means associated with the other chamber, the two said sections communicating with each other when the two chambers are placed in correct register with each other.

12. The apparatus according to claim 11, wherein at least a part of the wall of one said chamber in the region where one chamber is mounted adjacent the other is double skinned, comprising a first wall and a second wall with a space defined between them, the lower part of which space is open to the brewing chamber and the upper part of which space is open to the boiling chamber when the two chambers are placed in correct register with each other, whereby the said double skinned wall is adapted to serve as a baffle between the two chambers, with a weir on the side adjacent the boiling chamber, so that water that has previously boiled, held within the boiling chamber, may be used to replenish water in the brewing chamber poured off as tea by cascading over the weir and into the said space when the kettle is sufficiently tilted in pouring off tea.
